(19) United States
(12) Patent Application Publication
(10) Pub. No.: US 2026/0077466 A1
(43) Pub. Date: Mar. 19, 2026

(54) ATTACHMENT FOR A TOOL WITH SHOCK ABSORBING INSERT

(71) Applicant: MILWAUKEE ELECTRIC TOOL CORPORATION, Brookfield, WI (US)

(72) Inventor: Ryan T. Bumgarner, Milwaukee, WI (US)

(21) Appl. No.: 19/331,527

(22) Filed: Sep. 17, 2025

Related U.S. Application Data
(60) Provisional application No. 63/696,085, filed on Sep. 18, 2024.

(51) Int. Cl. B25D 17/00; B25D 17/24

(52) U.S. Cl. CPC B25D 17/005; B25D 17/24; B25D 2217/0073; B25D 2250/051; B25D 2250/331; B25D 2250/371

(57) ABSTRACT

An attachment includes a drive shank that is removably couplable to a tool, the drive shank having a groove in which the retention feature is disposed. An insert is coupled to the drive shank, and the insert is positioned in the groove of the drive shank and configured to engage a retention feature of the attachment.

### CROSS-REFERENCE TO RELATED APPLICATIONS

This application claims priority to co-pending U.S. Provisional Patent Application No. 63/696,085, filed on Sep. 18, 2024, the entire content of which is incorporated herein by reference.

### FIELD

The present disclosure relates to a shock absorbing insert for a tool attachment.

### BACKGROUND

An attachment for a tool may include gaps, or float, to allow assembly of the attachment with the tool. The tool often includes one or more retention features to retain the attachment. Due to the float between components, metal to metal contact may occur, reducing the life of the components.

### SUMMARY

The present disclosure provides, in one aspect, an attachment configured to be coupled to a tool having a retention feature, the attachment including: a drive shank removably couplable to the tool, the drive shank having a groove in which the retention feature is disposed; and an insert coupled to the drive shank, the insert positioned in the groove of the drive shank and configured to engage the retention feature.

The present disclosure provides, in another aspect, an attachment configured to be coupled to a tool having a retention feature, the attachment including: a drive shank removably couplable to the tool, the drive shank having a groove in which the retention feature is disposed; and an insert coupled to the drive shank, the insert positioned in the groove of the drive shank, the insert having an engagement surface configured to engage the retention feature and a coupling surface coupled to the groove.

The present disclosure provides, in another aspect, an attachment configured to be coupled to a tool, the attachment including: a body supporting a driving portion and an impact portion, the driving portion supporting a retention feature, the impact portion configured to slidably receive a rod to drive the rod; a drive shank removably couplable to the tool and the driving portion, the drive shank having a groove in which the retention feature is disposed; and an insert coupled to the drive shank, the insert positioned in the groove of the drive shank and configured to engage the retention feature.

Other features and aspects of the subject matter will become apparent by consideration of the following detailed description and accompanying drawings.

### BRIEF DESCRIPTION OF THE DRAWINGS

FIG. 1A is a top perspective view of an attachment for use with a powered hammer according to one embodiment of the present disclosure.

FIG. 1B is a bottom perspective view of the attachment of FIG. 1A.

FIG. 2 is a side view of the attachment of FIG. 1A.

FIG. 3 is a cross-sectional view of the attachment of FIG. 1A, taken along section line 3-3 in FIG. 1A.

FIG. 4A is a side view of an existing attachment in use.

FIG. 4B is a side view of the attachment of FIG. 1A in use.

FIG. 5 is a cross-sectional view of an attachment according to another embodiment.

FIG. 6 is a cross-sectional view of an attachment according to another embodiment and in a first position.

FIG. 7 is a cross-sectional view of the attachment of FIG. 6 in a second position.

FIG. 8 is a cross-sectional view of an attachment according to another embodiment and in a first position.

FIG. 9 is a cross-sectional view of the attachment of FIG. 8 in an intermediate position.

FIG. 10 is a cross-sectional view of the attachment of FIG. 8 in a second position.

FIG. 11A is a perspective view of a drive shank, including an insert.

FIG. 11B is a section view of the drive shank and insert of FIG. 11A.

FIG. 12 is a side view of the insert of FIG. 11A.

FIG. 13 is a section view of a drive shank inserted into the attachment.

FIG. 14A is a perspective view of a drive shank, including an insert.

FIG. 14B is a section view of the drive shank and insert of FIG. 14A.

FIG. 15 is a side view of the insert of FIG. 14A.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

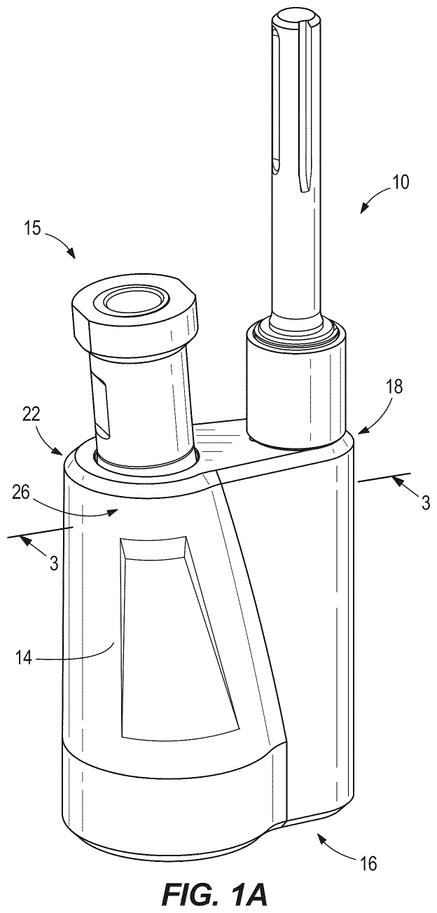

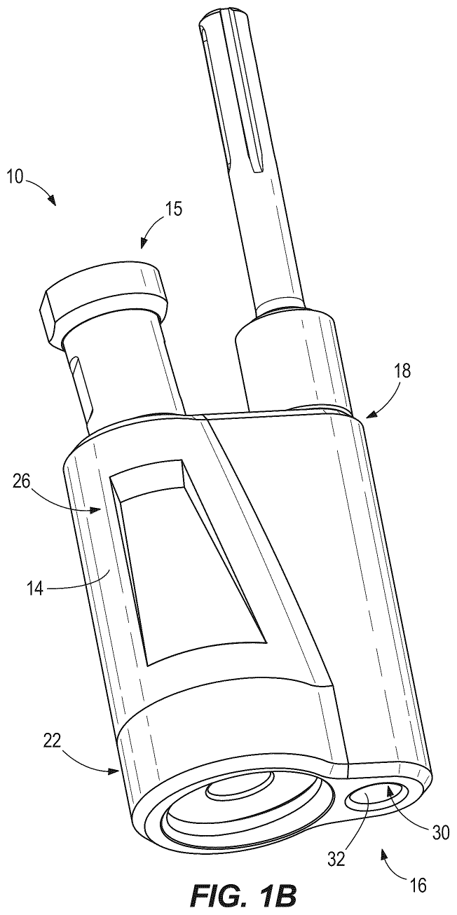

FIGS. 1A and 1B illustrate an attachment 10 configured for use with a reciprocating power tool (e.g., a powered hammer, not shown) to drive a rod 13 (FIGS. 4A, 4B) into the ground. The attachment 10 includes a body 14 having a first end 15 and a second end 16 opposite the first end 15. The attachment 10 further includes an impact portion 18 and a driving portion 22 disposed within the body 14. The impact portion 18 is positioned on the first end 15 of the body 14 and receives impacts from the powered hammer, and the driving portion 22 transmits a driving force generated by the impacts to the rod 13 to drive the rod 13 into the ground. More particularly, the illustrated driving portion 22 includes a side load driving portion 26 and a top load driving portion 30 (FIG. 1B). The side load driving portion 26 transmits the driving force to sides of the rod 13, while the top load driving portion 30 is positioned on the second end 16 of the body 14 and transmits the driving force to a top end of the rod 13. In operation, the side load driving portion 26 is used to drive the rod 13 into the ground until the rod 13 is nearly driven into the ground. When the rod 13 is nearly driven into the ground, an operator is able to switch to the top load driving portion 30 to complete driving the rod 13 into the ground. The attachment 10 of the present disclosure allows for efficient driving of the rod 13 into the ground, without the operator needing to switch attachments to complete the driving process.

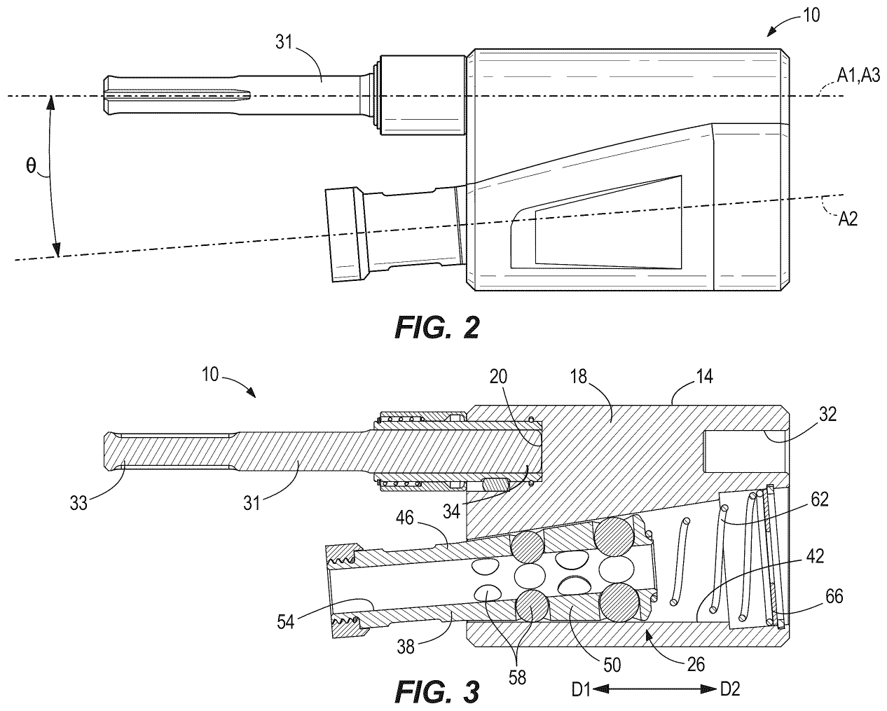

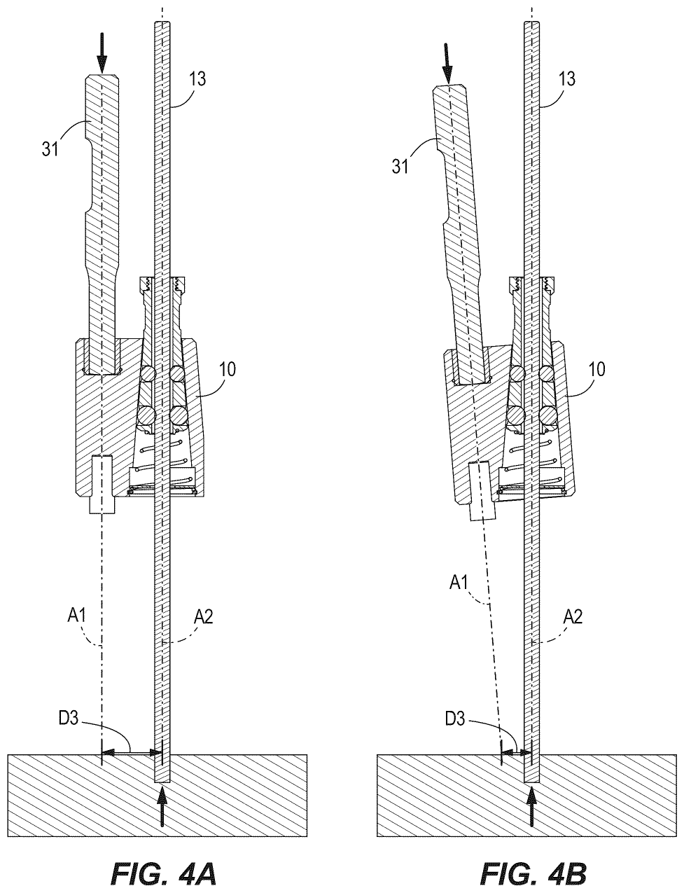

With reference to FIG. 3, the impact portion 18 is located on a first side of the body 14. The illustrated impact portion 18 includes a bore 20. More particularly, the bore 20 is a blind bore. A longitudinal axis of the impact portion 18 defines an impact axis A1 (FIG. 2). The impact portion 18 is shaped to receive a drive shank 31 of a powered hammer to couple the attachment 10 to the powered hammer. The powered hammer receives the proximal end 33 of the drive shank 31 and the impact portion 18 receives a distal end 34 of the drive shank 31. An interference fit may exist between the drive shank 31 and the impact portion 18 such that impacts from the powered hammer during operation secure the drive shank 31 within the impact portion 18 (e.g., the blind bore 20). The impact portion 18 may include a sizing feature, such as an insert, adapted to adjust a diameter of the impact portion 18 to accommodate different size shanks. In some embodiments, the drive shank 31 is coupled to the body 14 via a quick-connect system, rather than an interference fit, so that the drive shank 31 is replaceable. The quick connect system may be similar to a chuck of the powered hammer. In yet other embodiments, the drive shank 31 is a post extending from the body 14 and integrally formed with the body 14. The post is shaped to be received within the chuck of the powered hammer to received repeated impacts therefrom. Other attachment systems are described in more detail below.

With continued reference to FIG. 3, the side load driving portion 26 includes a one-way collet 38 for selectively securing the rod 13 relative to the body 14 of the attachment 10 and transmitting the driving force from the powered hammer into the rod 13 to drive the rod 13 into the ground. A longitudinal axis of the side load driving portion 26 defines a side load driving axis A2 (FIG. 2). The collet 38 allows the attachment 10 to move relative to the rod 13 in a first direction D1 along the side load driving axis A2 and prevents relative motion between the rod 13 and the attachment 10 in a second direction D2 along the driving axis A2. The second direction D2 is the driving direction (e.g., into the ground). In operation, the one-way collet 38 prevents the attachment 10 from moving along the rod 13 towards the ground, thereby facilitating the driving of the rod 13, while allowing the attachment 10 to be moved along the rod 13 away from the ground, thereby allowing the operator to re-position the attachment 10 along the rod 13 as the rod 13 is driven into the ground.

With continued reference to FIG. 3, the body 14 includes an aperture 42 in which the collet 38 is received. In the illustrated embodiment, the aperture 42 is a frustoconical aperture. The aperture 42 narrows towards a top of the attachment 10 (e.g., proximate the powered hammer). The illustrated collet 38 includes a cylindrical portion 46, a frustoconical portion 50, and a central bore 54 extending a length of the collet 38 and adapted to receive the rod 13 therein. The cylindrical portion 46 is located at a top of the collet 38 and extends beyond the body 14 of the attachment 10 through the narrow portion of the aperture 42. The frustoconical portion 50 is sized and shaped to fit within the frustoconical aperture 42 of the body 14. For example, the frustoconical portion 50 of the collet 38 has a similar slope to the frustoconical aperture 42 of the body 14. The slope of the illustrated embodiment is 5 degrees. In other embodiments, the slope of the collet 38 may be greater than or less than 5 degrees.

Spaced circumferentially about the frustoconical portion 50 are a plurality of ball bearings 58. The ball bearings 58 partially extend radially into the central bore 54 to engage the rod 13 and transmit driving forces to the rod 13. The collet 38 of the illustrated embodiment includes four rows of differently sized ball bearings 58. Each row of bearings 58 is offset from the rows above and/or below. In the illustrated embodiment, the offset angle between each row is 45 degrees. Each bearing 58 within a row is of the same nominal size, while bearings 58 in adjacent rows have different nominal sizes. The difference between bearing sizes in adjacent rows corresponds to the slope of the frustoconical portion 50. In other words, as the aperture 42 widens, the bearings 58 increase in size. This allows each bearing 58 to simultaneously engage the rod 13 when the rod 13 is inserted in the collet 38. In other embodiments, the collet 38 may include more or fewer bearings 58 in each row, more or fewer rows of bearings 58, and a greater or smaller offset between rows of bearings 58, depending on the desired size of the attachment 10 and desired diameter of rods 13 to be driven by the attachment 10. However, irrespective of the number or offset, the bearings 58 are sized to correspond to the slope of the frustoconical portion 50 to properly secure the rod 13. Each bearing 58 equally engages the rod 13 to reduce marring during the driving operation. Marring can decrease the grounding capabilities of the rod 13 after it is driven, and therefore should be avoided.

The side load driving portion 26 further includes a biasing member 62 to bias the collet 38 against the aperture 42 and an end cap 66 to secure the collet 38 within the aperture 42. In other words, the biasing member 62 is configured to bias the collet 38 towards the first end 15 of the body 14. The end cap 66 is located below the collet 38, and the biasing member 62 is disposed between the end cap 66 and the collet 38. In one embodiment, the biasing member 62 is a conical compression spring, and the end cap 66 is a washer secured within the aperture 42 by a snap ring. In another embodiment, the biasing member 62 is a cylindrical compression spring, and the end cap 66 is a cup extending from a bottom of the aperture 42 and secured to the aperture 42 via a threaded connection.

The side load driving portion 26 is capable of driving rods of various diameters. For example, the attachment 10 can be used to drive rods 13 of ½″, ⅝″, or ¾″ diameters. In some embodiments, the attachment 10 can be used to drive rods 13 of ⅜″ or 1″ diameters. The slope of the aperture 42 and frustoconical portion 50 dictates the size of rods 13 that can be driven. More particularly, the collet 38 is movable within the aperture 42, against the force of the biasing member 62, to accommodate larger diameter rods. As the collet 38 moves towards the end cap 66, the aperture 42 widens and allows the bearings 58 to move radially outwards to accommodate a larger diameter rod 13, while being able to contact both the body 14 and the rod 13. The use of a conical spring as the biasing member 62 allows for a shorter overall attachment length (e.g., the washer end cap 66 rather than the cup), because the conical spring is compressible to a flatter shape than a cylindrical compression spring. In other words, the use of a cylindrical compression spring requires the cup-shaped end cap to provide clearance for the collet 38 to move within the aperture 42 and accommodate larger diameter rods 13.

With reference to FIGS. 1B and 3, the top load driving portion 30 is illustrated as a blind bore 32 on a bottom side of the body 14 (e.g., the second end 16 of the body 14). A longitudinal axis A3 (FIG. 2) of the top load driving portion 30 is parallel with the impact axis A1. In the illustrated embodiment, the longitudinal axis A3 is coaxial with the impact axis A1. In some embodiments, the longitudinal axis A3 of the top load driving portion is offset from the impact axis A1 or non-parallel. Furthermore, in some embodiments, the top load driving portion 30 may be formed as a post extending below the body 14 and having the blind bore 32 therein.

In some embodiments, the body 14 includes an accessory receiving portion that is configured to receive an accessory that assists in the grounding operation. One such accessory is a step that can be fastened to the attachment 10. The step may include, for example a bar or strap extending from a side of the attachment 10. Another such accessory is a handle that can be fastened to the attachment 10 via fastener receiving holes. In operation, the step allows a user to apply a force to the attachment 10, and thus the rod 13, with their foot while driving the rod 13. This force can steady the rod 13 during driving and may also increase the efficiency of the driving by applying a downward force (e.g., in the same direction as the driving force).

The attachment 10 of the present disclosure is optimized for efficient driving of the rod 13. The optimization is in part due to decreasing the overall mass of the attachment 10. Having less mass below the impact point of the powered hammer results in a greater driving force being transmitted to the rod 13. To accomplish this, the overall size of the body 14 is decreased, and the body 14 is formed of lightweight and strong materials such as aluminum or magnesium. For example, compared to a similar attachment made of steel, an attachment made of aluminum may weigh about 65% less, while an attachment made of magnesium may weight about 80% less. In the illustrated embodiment, the impact portion 18 and the driving portion 22 of the body 14 are integrally formed as a single piece. In such embodiments, the impact portion 18 and the driving portion 22 may be formed of the same material. In other embodiments, the impact portion 18 and the driving portion 22 may be separate pieces that are secured (e.g., fastened, welded, etc.) together. In such embodiments, the impact portion 18 and the driving portion 22 may be formed of the same material or may be formed of different materials from each other.

Referring now to FIG. 3, the side load driving axis A2 is angled relative to the impact axis A1. In other words, the side load driving portion 26, the aperture 42, and the collet 38 are angled relative to the impact axis A1. The side load driving axis A2 and the impact axis A1 define an angle θ. The illustrated angle θ is an acute angle that is less than 20 degrees. Preferably, the angle θ is 4.5 degrees. In other embodiments, the angle θ may be greater than 20 degrees. In further embodiments, the side load driving axis A2 and the impact axis A1 are offset and parallel. Having the side load driving axis A2 angled relative to the impact axis A1 increases the rod driving efficiency by decreasing an offset distance D3 (FIG. 4B) between the impact axis A1 and the side load driving axis A2. A shorter offset distance between the impact axis A1 and the side load driving axis A2 decreases the bending moment arm applied to the rod 13 during impacts and allows more of the force from the impact to be transferred to the rod 13 to drive the rod 13 linearly into the ground. For example, as shown in FIG. 4A, an offset distance D3 is defined between the rod 13 and the impact axis A1 at a position where the rod 13 contacts the ground. The offset distance D3 is measured in a direction that is parallel to the ground or perpendicular to the rod 13. As illustrated in FIG. 4A, the offset distance D3 is generally going to be the offset distance between the impact axis A1 and the side load driving axis A2. However, as shown in FIG. 4B, by angling the side load driving axis A2 relative to the impact axis A1, the offset distance D3 can be reduced further or completely reduced to zero. In addition, by having the angle θ be small, the horizontal force vector applied to the rod 13 during operation is negligible allowing the vertical vector force provided to the rod 13 to be nearly the full force applied by the power tool to the impact portion 18.

In the illustrated embodiment, the side load driving portion 26 and the side load driving axis A2 are angled relative to the impact portion 18 and impact axis A1 so that the impact axis A1 remains generally parallel with the outside edge of the body 14. In other embodiments, the impact portion 18 and impact axis A1 may be angled relative to the side load driving portion 26 and side load driving axis A2 so that the side load driving axis A2 is generally parallel to the outside edge of the housing.

To drive a rod 13 with the above-described attachment 10, the operator first couples the attachment 10 to the powered hammer via the impact portion 18. In the illustrated embodiment, the drive shank 31 is inserted into the chuck of the powered hammer. If the attachment 10 has not been used before (e.g., the drive shank 31 is not secured within the impact portion 18), the operator also inserts the drive shank into the blind bore 20 of the impact portion 18. Next, the rod 13 is inserted into the side load driving portion 26 from above the attachment 10. The insertion direction corresponds to the direction D1 in which the collet 38 allows for relative movement of the rod 13 and the attachment 10 (e.g., opposite the driving direction D2). At this point, the rod 13 can be aligned with the ground at a desired location and the operator can actuate the powered hammer to begin driving the rod 13. As the rod 13 is driven, the operator adjusts the position of the attachment 10 relative to the length of the rod 13 until the rod 13 is nearly driven into the ground. At this point, the operator will release the side load driving portion 26 from the rod 13 and insert a top of the rod 13 into the top load driving portion 30 to complete driving the rod 13 into the ground. While the steps of a driving operation have been described in a particular order above, one or ordinary skill in the art will understand the ability to perform the steps in a different order.

Table 1 below illustrates the average time in seconds to complete driving rods 13 of different lengths into the ground using various attachments. As evidenced by the table, the attachment 10 with the side load driving axis A2 angled relative to the impact axis A1 reduced the driving time by over half compared to attachments that are not angled.

TABLE 1
Average Time (seconds) to Complete Driving Operation

| Sample Rod Size (feet) | 3 | 4 | 5 | 6 |
|---|---|---|---|---|
| Attachment #1 (not angled) | 75.95 | 107.24 | 136.53 | 201.89 |
| Attachment #2 (not angled) | 80.66 | 120.17 | 156.34 | 185.95 |
| Attachment 10 (angled) | 36.34 | 53.38 | 68.07 | 89.48 |

In some embodiments, hardened steel may be included to increase the strength of high wear areas of the body 14. For example, a hardened steel sleeve may be applied to the top load driving portion 30 so that the bore 32 is not overly worn during operation. Similarly, the collet 38 and the end cap 66 can be formed of high strength steel, and a different steel sleeve may be applied to the aperture 42 so that the bearings 58 do not mar the body 14 of the attachment 10 during use.

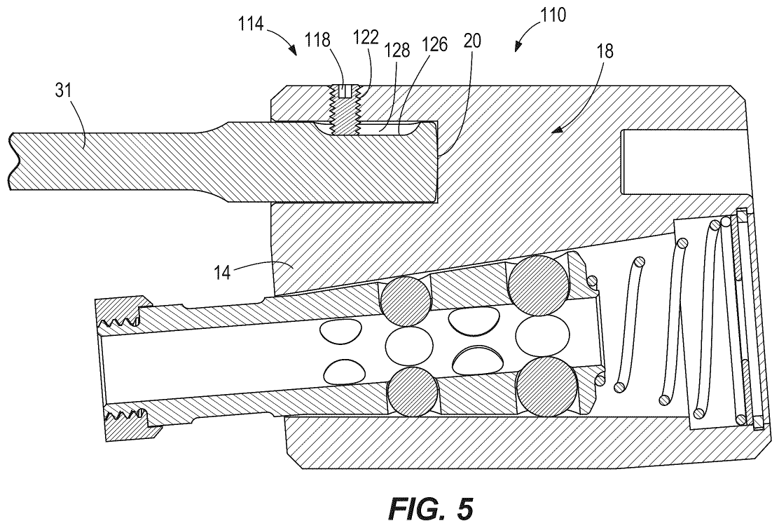

FIG. 5 illustrates an attachment 110 according to another embodiment of the subject matter. The attachment 110 is similar to the attachment 10 described above with like features being represented with like reference numbers. The illustrated attachment 110 includes a retention device 114 to selectively secure the shank 31 within the bore 20 of the impact portion 18. As mentioned above, the attachment 10, 110 may include a dedicated drive shank 31 that is removably coupled to the bore 20 of the impact portion 18. The retention device 114 includes a locking mechanism 118 that is received in an opening 122 in the body 14. In the illustrated embodiment, the locking mechanism 118 is a set screw. In other embodiments, the locking mechanism 118 may include other types of threaded or non-threaded fasteners or inserts. For example, the locking mechanism 118 may include a pin, a spring-loaded detent, a clevis pin, a spring pin, a quick-release pin, a through bolt with a nut, or the like. The opening 122 extends to the bore 20 of the impact portion 18. The drive shank 31 includes a recessed or flat surface side 126 that the locking mechanism 118 engages when the drive shank 31 is received within the bore 20. To couple the shank 31 to the attachment 110, an operator may place the drive shank 31 in the bore 20 and insert (e.g., thread) the locking mechanism 118 into the opening 122 to secure the drive shank 31 in place. Conversely, an operator may remove the locking mechanism 118 from the opening 122 in order to remove the drive shank 31 from the bore 20.

The engagement of the locking mechanism 118 and drive shank 31 provides a sufficient force to retain the drive shank 31 within the bore 20. However, due to the flat surface side 126 on the drive shank 31, the drive shank 31 is allowed to minimally move axially along the impact axis A1. In other words, the drive shank 31 is allowed to float within the bore 20. During operation of the attachment 110, large compressive forces are transferred to the attachment 110 through the drive shank 31 that is coupled to a percussive power tool. Allowing the drive shank 31 to float in the bore 20 during a drive operation lets the compressive force from the power tool transfer to the drive shank 31 and rod 13 without a resultant tensile force. As a result, fatigue failures to the drive shank 31 and attachment 110 are reduced. In addition, allowing the drive shank 31 to float in the bore 20 dampens the percussive force reducing user fatigue during a driving operation. Further, the retention device 114 allows a user to change a drive shank 31 that has broken without needing to buy a completely new attachment.

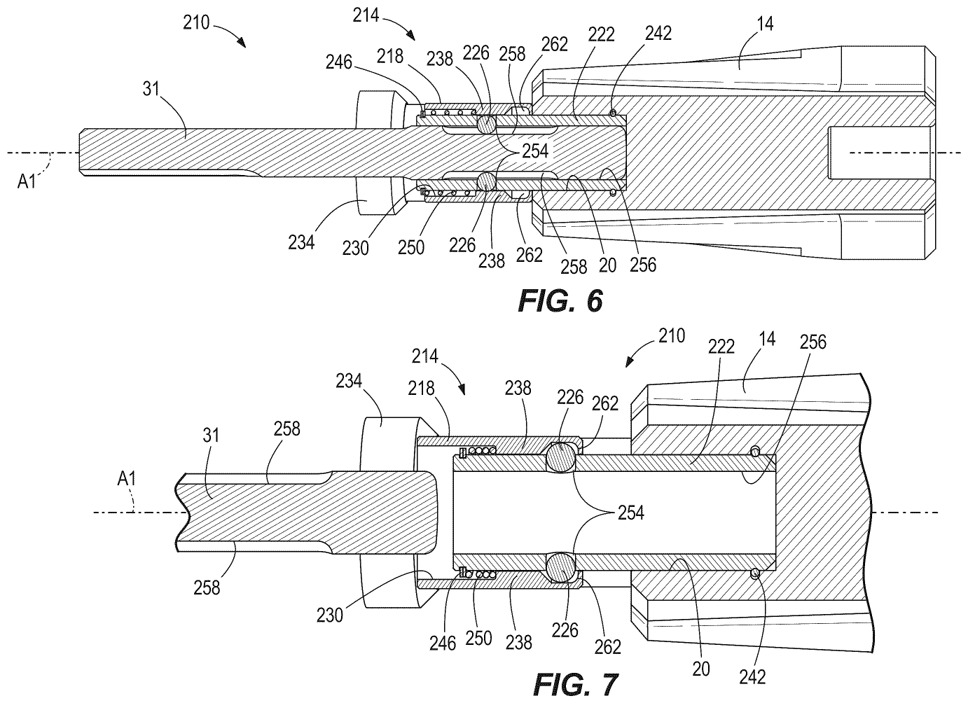

FIGS. 6 and 7 illustrate an attachment 210 according to another embodiment of the subject matter. The attachment 210 is similar to the attachment 10 described above with like features being represented by like reference numbers. The illustrated attachment 210 includes a retention device 214 to selectively secure the drive shank 31 to the attachment 210. The retention device 214 includes an external sleeve 218, an internal sleeve 222, and a locking mechanism (e.g., ball bearings 226). The external sleeve 218 is coupled to the body 14 adjacent the bore 20 and includes a channel 230 extending along the impact axis A1. The external sleeve 218 also includes an end cap 234 at one end and a pair of lips 238 extending from an interior surface of the channel 230 in a direction radially inward. The internal sleeve 222 is positioned within the external sleeve 218 and includes a portion that extends into the bore 20. A first snap ring 242 secures the internal sleeve 222 within the bore 20, and a second snap ring 246 assists in securing the internal sleeve 222 within the external sleeve 218. A biasing member (e.g., compression spring 250) is positioned within the channel 230 of the external sleeve 218 between the lips 238 and the second snap ring 246. The lips 238 and the second snap ring 246 act as spring seats for the biasing member 250. The biasing member 250 biases the external sleeve 218 axially towards the body 14. The ball bearings 226 are positioned within respective openings 254 in the internal sleeve 222. In the illustrated embodiment, the retention device 214 includes two ball bearings 226. In other embodiments, the retention device 214 may include fewer or more ball bearings 226.

In a locked position (FIG. 6), the lips 238 of the external sleeve 218 are positioned adjacent the openings 254 and the ball bearings 226. In the locked positioned, the lips 238 force the ball bearings 226 to partly extend into a channel 256 defined by the internal sleeve 222 to engage grooves 258 on the drive shank 31. The ball bearings 226 retain the drive shank 31 during a driving operation.

To remove or replace the drive shank 31 from the attachment 210, a user can pull up on the end cap 234 away from the body 14 and against the bias of the biasing member 250 to an unlocked position (FIG. 7). As the external sleeve 218 moves away from the body 14 of the attachment 210, the lips 238 on the inside surface of the channel 230 are removed from the openings 254 in the internal sleeve 222, allowing the ball bearings 226 to travel into pockets 262 of the external sleeve 218. With the ball bearings 226 removed from the internal channel 256, the drive shank 31 is allowed to be removed from the bore 20 of the impact portion 18. Conversely, a user can lift the end cap 234 away from the body 14 in order to couple the drive shank 31 to the attachment 210. Similar to the attachment 110 above, the ball bearings 226 allow the drive shank 31 to minimally move axially or float within the bore 20 in order to reduce fatigue to the drive shank 31 and attachment 210.

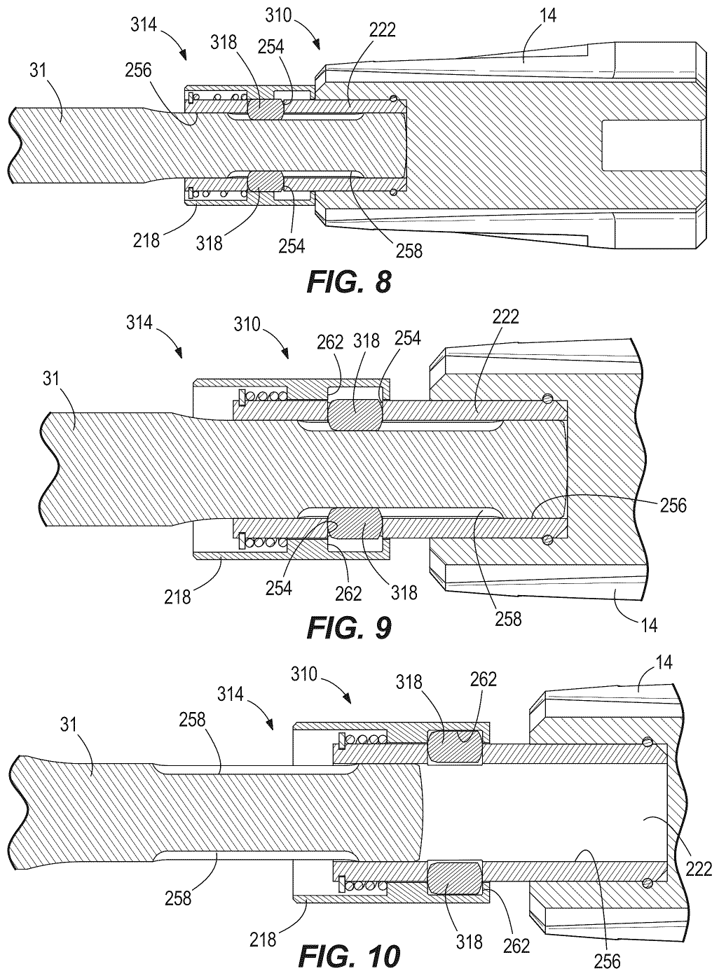

FIGS. 8-10 illustrate an attachment 310 according to another embodiment of the subject matter. The attachment 310 is similar to the attachment 210 described above, with like features being represented with like reference numbers. The illustrated attachment 310 includes a retention device 314 similar to the retention device 214 described above, however, the retention device 314 includes dowel pins 318 instead of ball bearings 226. In the illustrated embodiment, the retention device 314 includes two dowel pins 318. In other embodiments, the retention device 314 may include fewer or more dowel pins 318. The dowel pins 318 are resilient and cylindrical shaped so that the pins 318 are allowed to rotate within the openings 254 and compress within the openings 254. In addition, the pockets 262 of the external sleeve are sized to receive the dowel pins 318 instead of the ball bearings 226.

In the locked position (FIG. 8), the pockets 262 are offset circumferentially from the openings 254 of the internal sleeve 222 so a user also rotates the external sleeve 218 to release the drive shank 31. The pockets 262 may be offset from the openings 254 by up to 90 degrees. As such, to release the drive shank 31, the user first lifts the external sleeve 218 away from the body 14 as shown in FIG. 9. Next, a user rotates the external sleeve 218 in a first direction to align the pockets 262 with the openings 254, allowing the pins 318 to retreat from the channel 256 of the internal sleeve 222 and the grooves 258 on the shank 31 (FIG. 10). The user can then remove the drive shank 31 from the bore 20. Similar to the attachment 110 above, the dowel pins 318 allow the drive shank 31 to minimally move axially or float within the bore 20 in order to reduce fatigue to the drive shank 31 and attachment 310.

The attachments 10, 110, 210, 310 have been described with respect to driving electrical ground rods 13. However, one of ordinary skill in the art will understand that the attachment 10 can be used for driving other rods and stakes as well.

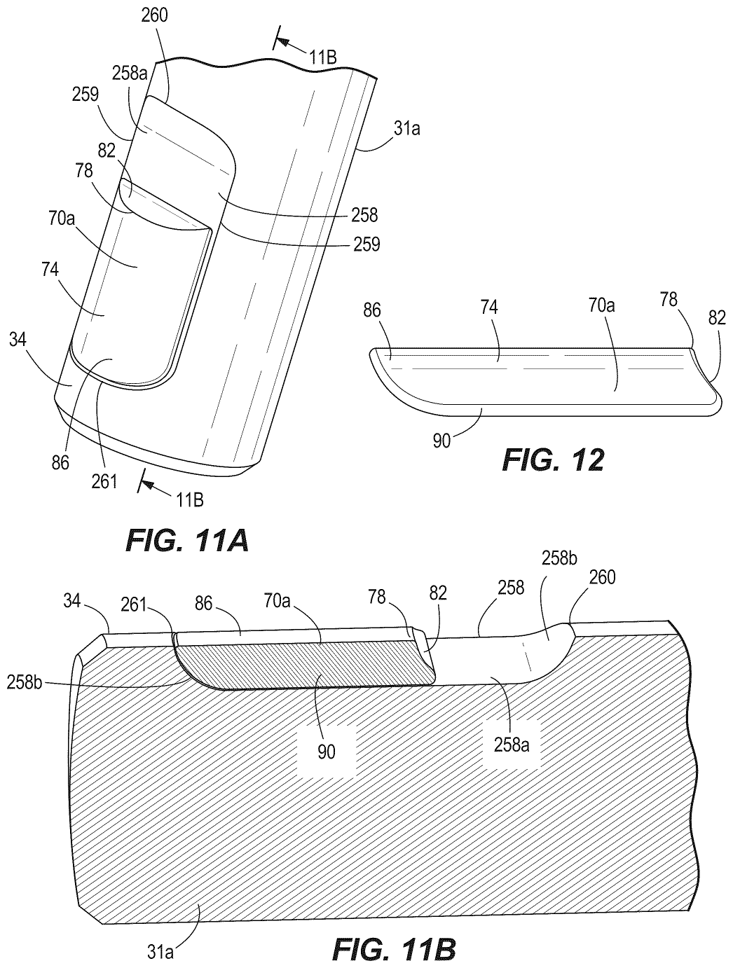

FIGS. 11A-11B, 12-13, 14A-14B, and 15 illustrate embodiments of a drive shank 31a, 31b that are removably couplable to an attachment (e.g., to ground rod driver attachment 10) and to a tool (e.g., a reciprocating power tool) for driving the drive shank 31a, 31b. Each of the drive shanks 31a, 31b includes an insert 70a, 70b coupled to the drive shank 31a, 31b in one or more grooves 258 of the drive shank 31a, 31b. The drive shank 31a, 31b has a proximal end 33 that is coupleable to the tool and a distal end 34 opposite the proximal end 33. The proximal and distal ends 33, 34 of the drive shank 31 are illustrated in FIG. 3 and should be understood to be substantially similar to the drive shank 31a, 31b. The groove 258 is positioned closer to the distal end 34 than to the proximal end 33.

The insert 70a, 70b may be made of a relatively soft material (in comparison to the material used for the drive shank), such as rubber or another elastomeric material. In other embodiments, harder rubbers or other materials may be used. The insert 70a, 70b may be coupled to the drive shank 31a, 31b by insert molding, glue, press-fitting, fasteners, etc. In another embodiments, the insert may be overmolded on the shank. In such embodiments, a shape of the insert may be achieved via machining or other material removal processes.

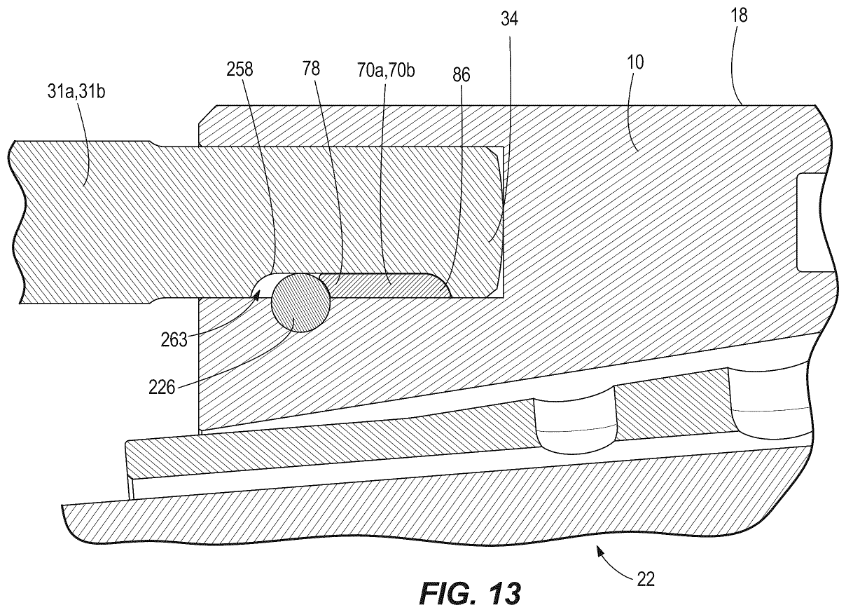

As shown in FIG. 13, the groove 258 has a proximal end 260 and a distal end 261. The distal end 261 of the groove 258 is closer to the distal end 34 of the drive shank 31a, 31b than the proximal end 260 of the groove 258 is positioned relative to the distal end 34 of the drive shank 31a, 31b. The groove 258 is formed (e.g., machined) to have a substantially planar, flat surface 258a extending between curved ends 258b that define the proximal and distal ends 260, 261. The proximal and distal ends 260, 261 of the groove 258 define a length of the groove. The flat surface 258a has sides 259 that define a width between the sides 259. In the illustrated embodiment, when the drive shank 31a, 31b is coupled to the impact portion 18 of the attachment 10, the groove 258 is positioned facing the driving portion 22.

The insert 70a, 70b is positioned in the groove 258 such that when the drive shank 31a, 31b is coupled to the attachment 10, 110, 210, 310, the insert 70a, 70b is positioned in the groove 258 closer to the ground than to the percussive tool. That is, the insert 70a, 70b is positioned at the distal end 261 of the groove 258. In other embodiments, the insert 70a, 70b may be positioned closer to the tool than to the ground. When the insert 70a, 70b is positioned in the groove 258, the insert 70a, 70b spans at least a majority of the width of the groove 258 and at least a majority of the length of the groove 258. As illustrated, the insert 70a, 70b spans the entire width of the groove 258. Each insert 70a, 70b has an outer surface 74, a first end 78, and a second end 86 opposite the first end 78. The outer surface 74 has a curved profile that has a diameter similar to or the same as the diameter of the corresponding drive shank 31a, 31b. That is, the outer surface 74 is substantially continuous with the outer surface of the drive shank 31a, 31b. The first end 78, or the engagement end, is the end of the insert 70a that is positioned away from the ground when the drive shank 31a, 31b is inserted into the attachment 10, 110, 210, 310. In the illustrated embodiment, the first end 78 has an engagement surface 82 having a curved profile that is configured to engage and receive the locking mechanism 118, ball bearings 226 (shown in FIG. 13) of the retention device 214, or dowel pins 318 of the retention device 314). The engagement surface 82 and the edge of the curved end 258b at the proximal end 260 of the groove 258 define a gap 263 in which the retention device 314 (e.g., ball bearing 226) is at least partially disposed. In the illustrated embodiment, the gap 263 has a width, or distance between the curved end 258b and the engagement surface 82 that is greater than an outer dimension (e.g., a diameter, a length, etc.) of the retention feature. In other embodiments, the width may be substantially similar to or smaller than the width of the retention feature. The second end 86 of the insert 70a has a curved profile that substantially follows the profile of the curved end 258b of the distal end 261 of the groove 258.

In the first embodiment illustrated in FIGS. 11A, 11B and 12, the insert 70a has a planar, that is, substantially flat coupling surface 90 coupled to the flat surface 258a of the groove 258. In other embodiments, the groove may have different geometry and the coupling surface has substantially similar geometry matching the groove.

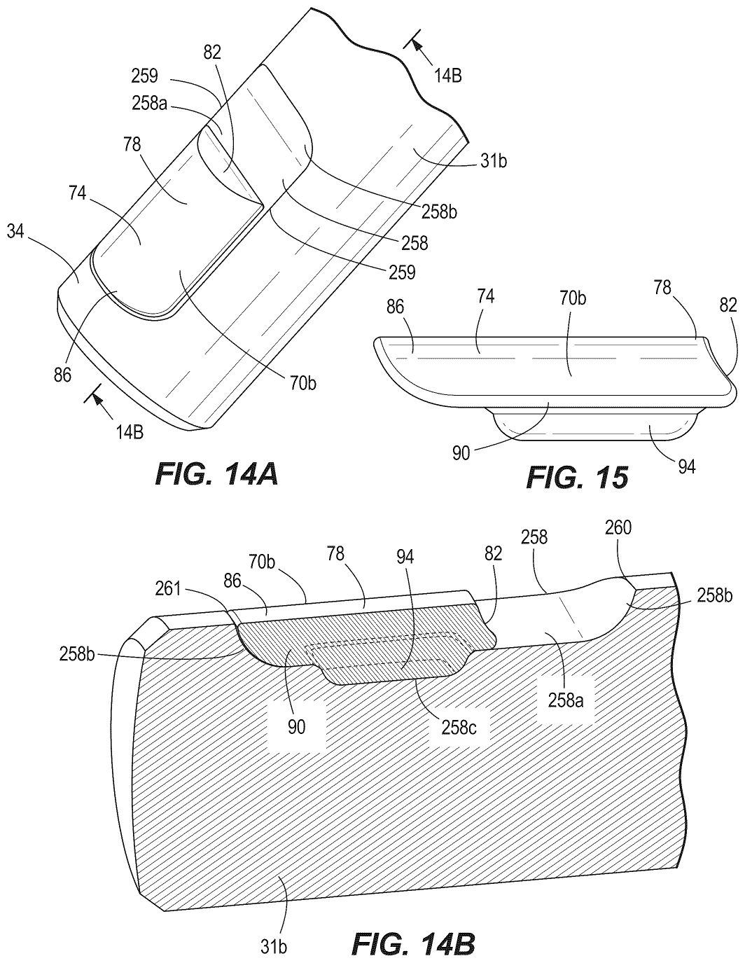

The second embodiment of the insert 70b, illustrated in FIGS. 14A, 14B, and 15, is substantially similar to the insert 70a described above. The insert 70b includes an extrusion 94 that extends from the coupling surface 90 into a recess 258c that extends from the flat surface 258a of the groove 258. The extrusion 94 helps locate the insert 70b on and couple the insert 70b to the drive shank 31b.

The insert 70a, 70b may be a silicon rubber, a fluoroelastomer (e.g., FKM, etc.), a nitrile rubber (e.g., NBR), or other grease/oil resistant material that is capable of withstanding compression and rebounds to its original shape, as well as high temperatures and high friction. In other embodiments, the material may be a HNBR material, for instance, for high temperature operation. The insert material may have a hardness (durometer) between 50 and 100 on a Shore A scale, for instance, a durometer between 60 and 80, such as a 70 durometer material. The resiliency and durability of the material used for the insert 70a, 70b absorb at least a portion of the percussive force of the drive shank 31a, 31b as the groove 258 of the drive shank 31a, 31b contacts the locking mechanism 118, ball bearings 226 of the retention device 214, or dowel pins 318 of the retention device 314, due to the float of the drive shank 31a, 31b in the bore 20. The insert 70a, 70b also reduces the amount of float of the drive shank 31a, 31b when coupled to the attachment 10 due to the reduced free space in the groove 258. The insert 70a, 70b also dampens the percussive force, reducing fatigue and improving the lifespan of the locking mechanism 118 or retention device 214, 314.

Although the subject matter has been described in detail with reference to certain preferred embodiments, variations and modifications exist within the scope and spirit of one or more independent aspects of the subject matter as described. Various features and advantages of the disclosure are set forth in the following claims.

What is claimed is:

1. An attachment configured to be coupled to a tool having a retention feature, the attachment comprising:
a drive shank removably couplable to the tool, the drive shank having a groove in which the retention feature is disposed; and
an insert coupled to the drive shank, the insert positioned in the groove of the drive shank and configured to engage the retention feature.

2. The attachment of claim 1, wherein the drive shank has a proximal end that is removably couplable to the tool and a distal end, and the groove is positioned closer to the distal end than to the proximal end.

3. The attachment of claim 2, wherein the groove has a proximal end and a distal end, the distal end of the groove being closer to the distal end of the drive shank than the proximal end of the groove, and the insert is disposed at the distal end of the groove.

4. The attachment of claim 1, wherein the groove has a planar surface joining a first curved end and a second curved end.

5. The attachment of claim 1, wherein the groove defines a recess, and wherein the insert has an extrusion that is positioned in the recess.

6. The attachment of claim 5, wherein the insert spans a majority of a width of the groove.

7. The attachment of claim 6, wherein the insert spans a majority of a length of the groove.

8. The attachment of claim 1, wherein the insert has an engagement surface that is configured to engage the retention feature, the engagement surface having a curved profile.

9. The attachment of claim 1, wherein the insert is composed of an elastomeric material.

10. The attachment of claim 1, wherein the insert is coupled to the drive shank by one or more selected from a group consisting of an insert molding process, a glue, a press-fitting process, or a fastener.

11. An attachment configured to be coupled to a tool having a retention feature, the attachment comprising:
a drive shank removably couplable to the tool, the drive shank having a groove in which the retention feature is disposed; and
an insert coupled to the drive shank, the insert positioned in the groove of the drive shank, the insert having an engagement surface configured to engage the retention feature and a coupling surface coupled to the groove.

12. The attachment of claim 11, wherein the coupling surface has a planar portion that is coupled to a planar surface of the groove.

13. The attachment of claim 12, wherein the insert includes an extrusion that extend from the planar surface and is disposed in a recess of the drive shank.

14. The attachment of claim 12, wherein the coupling surface has a curved portion that is coupled to a curved face of the groove.

15. The attachment of claim 11, wherein the engagement surface has a curved profile.

16. The attachment of claim 11, wherein the insert has a curved outer surface that is substantially continuous with an outer surface of the drive shank.

17. The attachment of claim 11, wherein the drive shank has a proximal end to which the tool is coupled and a distal end, and wherein the insert is positioned in the groove closer to the distal end than to the proximal end.

18. An attachment configured to be coupled to a tool, the attachment comprising:
a body supporting a driving portion and an impact portion, the driving portion supporting a retention feature, the impact portion configured to slidably receive a rod to drive the rod;
a drive shank removably couplable to the tool and the driving portion, the drive shank having a groove in which the retention feature is disposed; and
an insert coupled to the drive shank, the insert positioned in the groove of the drive shank and configured to engage the retention feature.

19. The attachment of claim 18, wherein the groove is positioned facing the impact portion.

20. The attachment of claim 19, wherein the insert and the groove define a gap between the insert and an edge of the groove, the gap having a width that is greater than an outer dimension of the retention feature.
